(19) United States
(12) Patent Application Publication
(10) Pub. No.: US 2020/0107994 A1
(43) Pub. Date: Apr. 9, 2020

(54) MEDICATION MANAGEMENT SYSTEM FOR INDIVIDUALS

(71) Applicant: D.C. Premier Sales, Inc., Huntington Station, NY (US)

(72) Inventor: Evelyn Bernfeld, Huntington Station, NY (US)

(21) Appl. No.: 16/590,352

(22) Filed: Oct. 1, 2019

Related U.S. Application Data
(60) Provisional application No. 62/741,412, filed on Oct. 4, 2018.

(51) Int. Cl. A61J 1/18; A61J 1/10; A45C 11/00; A45C 3/06; A45C 13/10

(52) U.S. Cl. CPC A61J 1/18; A61J 1/10; A45C 11/00; A45C 3/06; A45C 2011/007; A61J 2205/30; A61J 2205/40; A61J 2205/50; A45C 13/103

(57) ABSTRACT

Provided is a medication management system comprising; a) seven or more bags with a compartment for placement of pharmaceutical dosage forms, with at least one bag for each day of a week, each bag having a slot that is isolated from the compartment; b) at least seven bands for attaching the bags, each band having a letter and/or Braille representing a different day of the week, the bands configured to go through the slot of the bag and form a loop, each band having a fastener configured to fasten the band in the looped configuration; and c) a handbag for placement of all the bags and the bands; wherein a user had an option to detachably attach one or more bags to the same band.

### CROSS-REFERENCE

The present application claims the benefit of U.S. Provisional patent application No. 62/741,412, filed on Oct. 4, 2018, which is incorporated herein by reference in its entirety.

### BACKGROUND SECTION OF THE INVENTION

A portion of the population takes drugs and supplements on a daily basis. Some of these people need to put their weekly medications in pill boxes to remember which pill to take on each day of the week. A problem with pill boxes is that they are inflexible and generally contain the same compartment size for each day. The compartment size may not be sufficient fora user and the user has to typically carry the entire pill box for the week. There is a need in the art for a medication management system that addresses the above drawbacks.

### SUMMARY SECTION OF THE INVENTION

Provided is a medication management system with unique pill bags and holders. The system which can be a kit or a package, can have a plurality of food and/or medical grade plastic bags with a zipper closure. The medication management system is configured to be portable. Patients can take only the daily medication that they need with them. The bags can be removed to take from one day to one week's (one day, two days, three days, four days, five days, six days, seven days) worth of medication, making the system customizable. The bags can fit large pills, such as capsules, including capsules that contain drugs and/or supplements. The bags stay closed in a secure manner, such as with a zipper. The bags can be waterproof and can further be placed in a handbag (optionally waterproof) to keep moisture away from the medication. The handbag can have a zipper with an opening that complements an opening in another member attached to the bag, which allows a consumer to lock a zipper with an external lock. The bag can also be designed with a built-in lock. A discreet handbag can provide privacy. Plastic zip bags can be labeled for and/or personalized with time of day when the medication needs to be taken. Brightly colored bands provide Braille assist for patients that are visually impaired so that they know what day to take, the medications. Bags containing medication for same day can be held together with a single band. The bands provide flexibility to add as many multiple bags to the same band as necessary. The medication management is configured to be customizable, allowing a user to attach different numbers of bags to the same band for a single day.

A medication management system comprising of one or more bags, each bag having a first resealable opening for accessing a compartment of the bag for the placement of medication, and further having a second opening for attachment and/or inserting and/or placement of a holder. The first opening can be a zipper opening, with or without a slider. The second opening can be a slot. The slot can be vertically positioned on a side of the bag. The slot provides no access to the compartment. A holder, such as in the shape of a band, is passed through/inserted into the slot. The holder can indicate the day of the week. The bag can have a printed matter thereon for a user to indicate the time for taking the medication. The bags (for different days of the week) can be placed in a bigger handbag. Multiple bags can be attached to the same holder 5/band, allowing a user to add as many bags as needed for a particular day. A user can keep medication in separate bags, and need not put all medication in the same bag for a particular day. Also provided is an assembly/combination comprising of one or more bags, and a holder, such as a band. The assembly/combination can include multiple bags attached to the same band. There can be bag for the same day, or two bags if the medication is taken twice a day, or three bags if the medication is taken three times a day. Also included is a package or kit having bags and holders, either in assembled or non-assembled position. The handbag can have a strap and/or a flap and/or a zipper.

Provided is a method for storing medication in a portable manner comprising placing the medication to be taken in a single day in a plurality of bags, and attaching the bags together. The bags can be those described herein with a first and a second opening, and a holder as described herein can be used to keep the bags together.

Provided is a medication management system comprising; a. one or more bags for placement of pharmaceutical dosage forms; b. a holder for attaching to the bags; c. an indication on the holder representing a day of the week; wherein a user detachably attaches one or more bags to the holder.

Provided is a medication management system comprising; a. seven or more bags with a compartment for placement of pharmaceutical dosage forms, with at least one bag for each day of a week, each bag having a slot that is isolated from the compartment; b. at least seven bands for attaching the bags, with band having a letter and/or Braille representing a different day of the week, the bands configured to go through the slot of the bag and form a loop, each band having a fastening system configured to fasten the band in the looped configuration; and c. a handbag for placement of all the bags and the bands; wherein a user had an option to detachably attach one or more bags to the same band.

Provided is a method for storing medication in a portable manner comprising: a. placing pharmaceutical dosage forms in one or more bags; b. attaching a holder to the bags, wherein the holder has a letter and/or Braile indicating a day of the week; and wherein a user detachably attaches one or more bags to the holder and identifies the day of the week based on the indication on the holder.

### BRIEF DESCRIPTION OF THE DRAWINGS

FIG. 1 illustrates two bags attached to a single band with an F indication for Friday.

FIG. 2 illustrates a bag attached to a single band with an F indication for Friday.

FIG. 3 illustrates a bag attached to a single band.

FIG. 4 illustrates top side view of bag attached to a single band.

FIG. 5 illustrates bottom side view of a bag attached to a single band.

FIG. 6 illustrates left side of a bag attached to a single band with an F indication for Friday,

FIG. 7 illustrates right of a bag attached to a single band with an F indication for Friday.

FIG. 8 illustrates a handbag with bags with bands for different days, including Monday, Tuesday, Wednesday, Thursday, Friday, Saturday, and Sunday (seven days of the week).

### DETAILED SECTION OF THE INVENTION

Provided is a medication management system comprising one or more bags 1 for placements of medication or dietary supplements 2, each bag 1 having a re-sealable opening 3, and further having an opening 4 configured to receive one or more holders 5. The medication or dietary supplement 2 can be in form of oral dosage forms such as a pill, table, and/or capsule, in liquid or solid form. Dietary supplements include powders, protein powders, and/or vitamins. The holder 5 opening 4 can be rectangular in shape and go across both sides of the bag 1. The holder 5 opening 4 can be configured to be separate from the compartment (not have access to the compartment) of the bag 1 where the medication 2 is placed. The holder 5 opening 4 can be a vertical oval or a rectangular opening, including a rectangular opening 4 with round corners or a slit. The holder 5 allows adding as many bags 1 as needed. This flexibility allows for a user to customize each holder 5 with a number of bags 1 having medication for different times of the same day. Different days can have different number of bags, and anew bag can be inserted or removed at any time from the same holder 5.

An assembly/combination can be formed by detachably attaching the holder 5 to the bag 1. A holder 5 can be attached to a plurality of bags 1, such as 1, 2, 3, or more as desired by a consumer (such as 4, 5, 6 bags). Usually the consumer uses one bag 1 if the medication is taken once a day, two bags 1 if the medication is taken, twice a day, and three bags 1 if the medication is taken three times a day. The holder 5 can indicate the day of the week, and can allow a user to attach as many bags 1 as necessary to the holder 5 for that day of the week. The user can also put medication to be taken at different times on the same day in different bags 1. In addition, a user can use a darker colored bag 1 (brown, black) for any medication that is sensitive to light, such as vitamin D. The handbag 8 (inside of which bags 1 are placed) can also block out light. The kit/package can contain both transparent and opaque/translucent bags 1.

In one embodiment, a bag 1 is used with a zipper 6 on top that can be opened or sealed by a consumer. In another embodiment, the zipper 6 can be placed on the side. The zipper 6 can have an optional slider 7 which facilitates easier access for the dexterity challenged consumer. The band 5 can also be designed with a longer piece in the back and, easy to grab piece in the front to help the dexterity challenged.

To create the holder 5 opening 4, a small portion (such as 0.2 to 1 cm/1.5 cm) on one side of the bag 1 can be heat sealed so that the two layers that make the bag 1 seal together. A holder 5 opening 4 can then be created on the heat sealed side. For example, a rectangular or oval and/or vertical cut slit 4 is made in the heat sealed side of the bag 1.

In another embodiment, the holder 5 opening is attached to outside of the bag 1. Typically, a holder 5 opening is added to the side of the bag 1 by heat sealing or other techniques.

The holder 5 opening can be about 1.5 cm to about 3 cm long, and about 0.1 to about 0.05 cm wide. The bag 1 can be about 5 cm to about 10 cm tall, and about 10 cm to 16 cm wide. A typical bag 1 is about 7 to 8 cm tall and about 12 to 14 cm wide, and has a holder 5 opening in vertical orientation that is about 2 cm to about 3 cm in length.

Each bag 1 can further include printed material 9 on one or both sides indicating the time for taking the medication. In one embodiment, a white box is printed on one side of the bag 1. On the white box it can state “Time: _____ AM/PM”. The space allows a person to put the exact time on the space provided on the white box, and then circle one of AM, PM, or both. The patient can put multiple dosage 2 forms in one bag 1.

A holder 5 is attached to each bag 1 indicating the day of the week that a user should take the medication inside the bag 1. The holder 5 can be in form of a band, such as a rectangle. Seven different colored holder 5 can be used indicating each day of the week. The name of the day of the week or a portion thereof (such as first one or two letters) can be placed on the holder 5. The name of the week can be placed in dark black letters 8 and can optionally be embossed. In one embodiment, none of the colored bands 5 are black, allowing for placement of distinctive black letters on the color bands 5. The bands 5 further have raised embossed Braille 11 to help the blind (or visually impaired) identify the day of the week. The bands 5 can further have an electronic component with a speaker and a button that when pressed states the day of the week.

The height of the band 5 is less than the length of the holder 5 opening/slot so that the band can be placed (inserted through) in the slot 4. The band 5 can have a height of about 1.5 cm to about 2.1 cm. The length of the band can be about 10 cm to about 15 cm.

The band loops around the holder 5 opening/slot 4. The band can have a fastener 12 on its bottom for removable attachment of the band to itself. One option is placement of hook fasteners (VELCRO) at the bottom of each end of the hand. The bands 5 can be made from silicone/EVA or PVC and can be reusable.

The medication management system can come in form of a kit or package with bags 1 and holders 5 placed in a handbag 8. The handbag 8 can itself have a zipper and be of, a suitable size for placement of plurality of bags 1 and holders 5 (bands 5). The handbag 8 can have a loop or other member that can be, locked to the zipper to make the carry bag 8 child resistant/proof and/or to secure the content of the handbag 8. The handbag 8 can further have a handle/strap and a hook and loop closure/flap.

To use the medication management system, a user opens the bags 1 and puts the medication 2 inside each bag 1, and then seals the zipper 6 of the bag 1. The user then attaches each bag 1 with a specific band/holder 5 indicating the day of the week. The bag 1 can be inserted through the opening slot 4 of the bag 1. The user can attach multiple bags 1 to the same band 5. The user can rite the time of the day on the printed white box 9 of the bag 1. The user can put the bags 1 in a handbag 8. When a user wants to take the medication, the user opens the handbag 8, and locates the medication 2 for the day of the week. The user then takes the medication 2 from the bag 1. The user does not need to take the bag 1 out of the holder 5 to open the compartment of the bag 1 to access the medication 2.

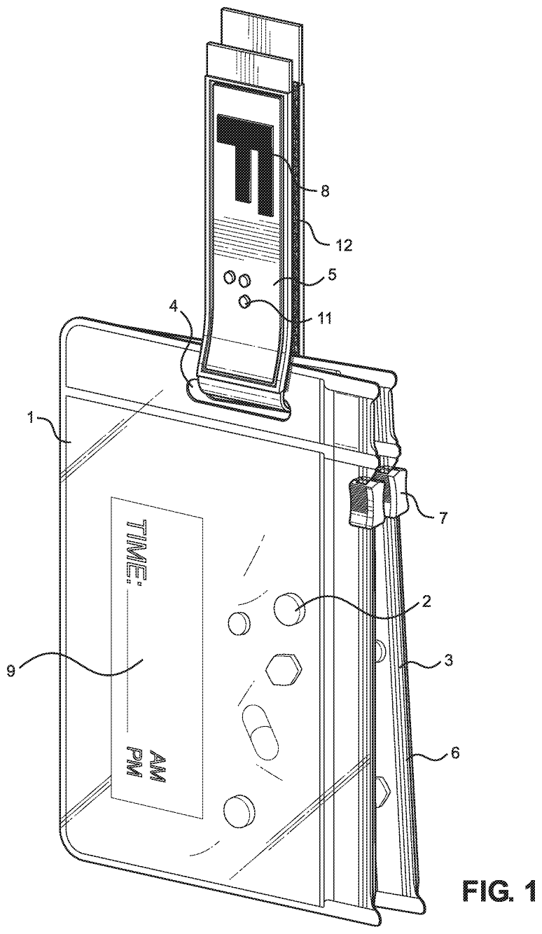

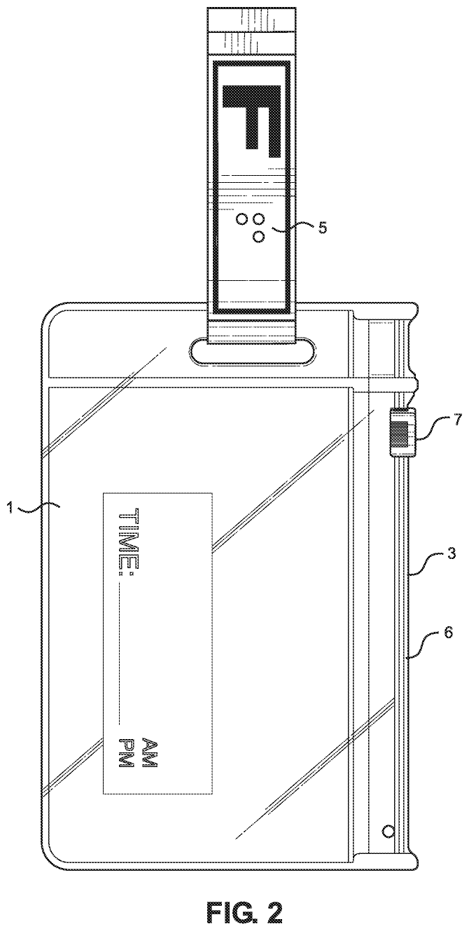

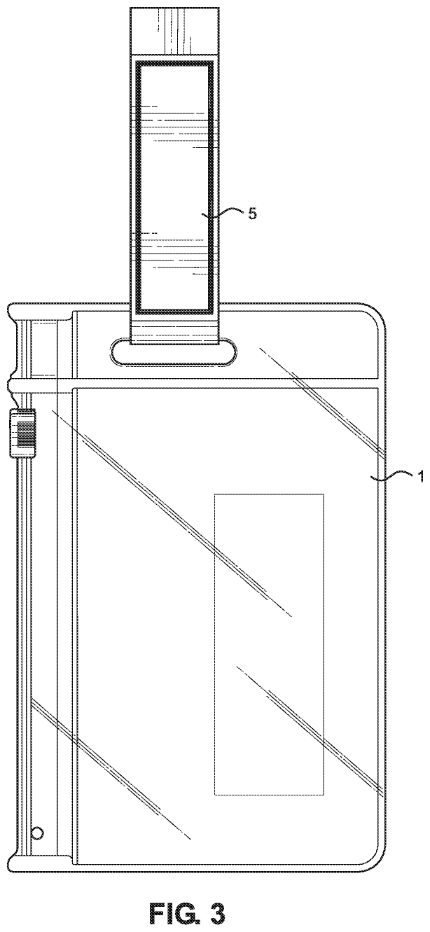

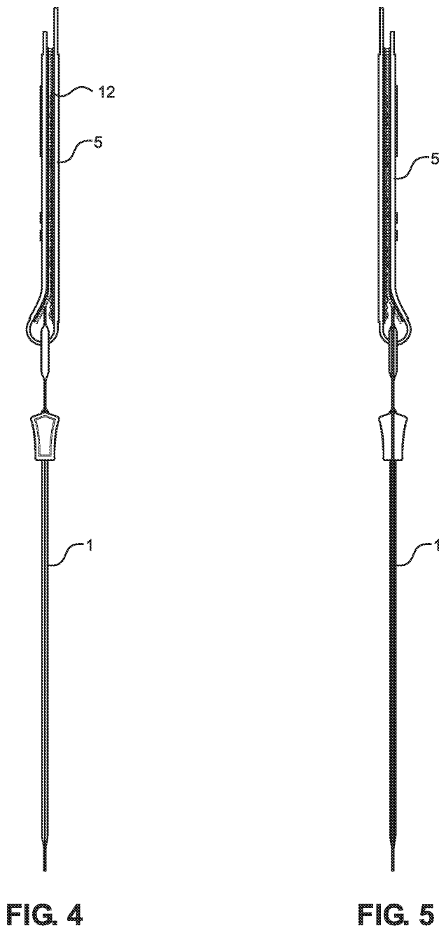

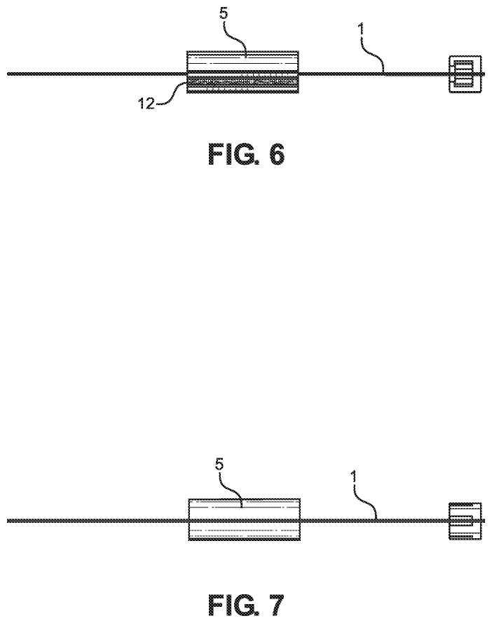

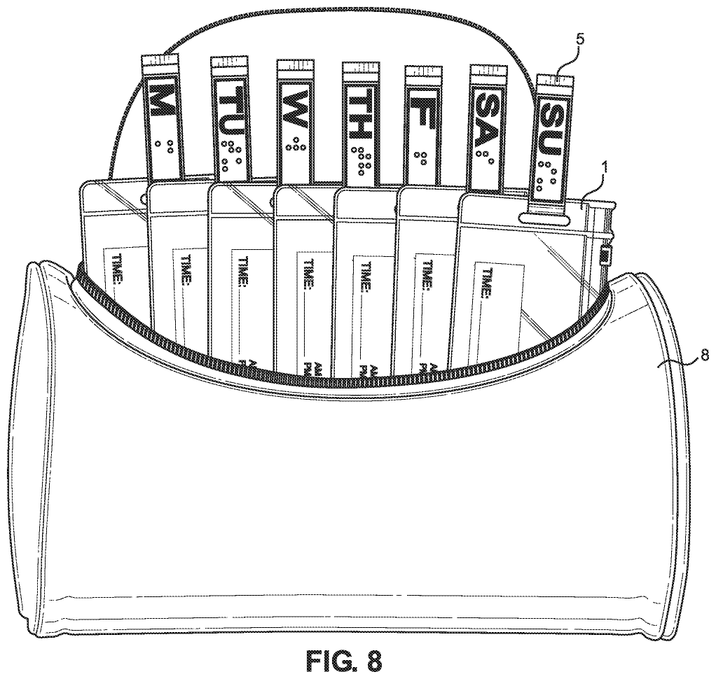

FIG. 1 illustrates two bags 1 attached to a single band 5 with an F indication for Friday. It is possible to attach from 1 to 10 bags 1 for each day depending on the length of the band. FIG. 2 illustrates a bag 1 attached to a single band with an F indication for Friday. FIGS. 1-7 illustrate the band 5 making a loop around the slot of the bag 1 and being closed, with a fastener 12 on the bottom of the band. Fastener 12 is illustrated in FIGS. 1, 4, 5, and 6. Pills and capsules are illustrated inside the bag with the slider of the zipper in a closed position. FIG. 8 illustrates seven different bags/bands assemblies for each day of the week placed in a handbag. The handbag can have a zipper.

What is claimed is:

1. A medication management system comprising:
a. one or more bags for placement of medication or a dietary supplement;
b. a holder for attaching to the bags;
c. an indication on the holder representing a day of the week;
wherein a user detachably attaches one or more bags to the holder.

2. The medication management system of claim 1, wherein the bag has a zipper closure.

3. The medication management system of claim 1, wherein the bag does not have a day indication.

4. The medication management system of claim 1, wherein the indication is in form of Braille.

5. The medication management system of claim 1, wherein the indication is in form of a letter.

6. The medication management system of claim 1, where the holder is in form of a band.

7. The medication management system of claim 1, wherein same day medications to be taken at different times are held together in different bags with a single band.

8. The medication management system of claim 1, wherein the holder is configured to hold, one to three bags.

9. The medication management system of claim 1, further comprising an opening on the bag for the holder to loop around.

10. The medication management system of claim 1, further comprising complementary fastening system on the holder.

11. The medication management system of claim 9, wherein the opening is in form of a slot.

12. The medication management system of claim 9, wherein the opening provides no access to a compartment of the bag where the medication is stored.

13. The medication management system of claim 1, further comprising printed matter on the bag for a user to indicate the time for taking the medication.

14. The medication management system of claim 1, further comprising a handbag for placement of the bags inside of the handbag.

15. The medication management system of claim 1, wherein the indication is a letter and Braille representing a day of the week.

16. The medication management system of claim 1, wherein the bag is about 5 cm to about 10 cm tall, and about 10 cm to 16 cm wide.

17. A medication management system comprising;
a. seven or more bags with a compartment for placement of a medication or a dietary supplement, with at least one bag, for each day of a week, each bag having a slot that is isolated from the compartment;
b. at least seven bands for attaching the bags, with band having a letter and/or Braille representing a different day of the week, the bands configured t go through the slot of the bag and form a loop, each band having a fastening system configured to fasten the band in the looped configuration; and
c. a handbag for placement of all the bags and the bands;
wherein a user had an option to detachably attach one or more bags to the same band.

18. The medication management system of claim 17, wherein the bag is about 5 cm to about 10 cm tall, and about 10 cm to 16 cm wide.

19. A method for storing medication in a portable manner comprising:
a. placing medication or a dietary supplement in one or more bags;
b. attaching a holder to the bags, wherein the holder has a letter and/or Braille indicating a day of the week; and
wherein a user detachably attaches one or more bags to the holder and identifies the day of the week based on the indication on the holder.

20. The method of claim 19, wherein a single holder is attached to three bags.
